(19) United States
(12) Patent Application Publication
(10) Pub. No.: US 2025/0323313 A1
(43) Pub. Date: Oct. 16, 2025

(54) SULFIDE SOLID ELECTROLYTE FOR LITHIUM SECONDARY BATTERY WITH EXCELLENT MECHANICAL PROPERTIES AND METHOD OF MANUFACTURING SAME

(71) Applicants: Hyundai Motor Company, Seoul (KR); Kia Corporation, Seoul (KR)

(72) Inventors: Sang Soo Lee, Seoul (KR); Hong Seok Min, Seoul (KR); Sang Heon Lee, Seoul (KR); So Young Kim, Seoul (KR); Dae Yeon Hwang, Seoul (KR); Kwang Jin Kim, Seoul (KR); Byeong Sun Jun, Seoul (KR); Wo Dum Jung, Seoul (KR); Geun Hyeong Shin, Seoul (KR); Jae Young Kim, Seoul (KR); In Woo Song, Seoul (KR); Ho Cheol Shin, Seoul (KR)

(21) Appl. No.: 18/909,383

(22) Filed: Oct. 8, 2024

(30) Foreign Application Priority Data
Apr. 12, 2024 (KR) 10-2024-0048990

(51) Int. Cl. H01M 10/0562; C01G 30/00; H01M 4/04; H01M 10/0525

(52) U.S. Cl. CPC H01M 10/0562; C01G 30/008; H01M 4/0404; H01M 10/0525; C01P 2002/82; C01P 2004/38; C01P 2006/10; H01M 2220/20

(57) ABSTRACT

A sulfide-based solid electrolyte with an argyrodite crystal structure is represented by the formula Li_{7-x-3y}Sb_{y}PS₆₋ₓHaₓ, where Ha is one or more halogen elements selected from F, Cl, Br, I, and their combinations, is disclosed. The sulfide-based solid electrolyte comprises a substituted antimony (Sb) element in Wyckoff position 48h of the argyrodite crystal structure instead of Li. The sulfide-based solid electrolyte exhibits a downshifted argyrodite Raman peak compared to an electrolyte without antimony substitution. The disclosed solid electrolyte may be synthesized using a ball milling process to ensure uniform distribution of staring materials and achieve a disordered crystal structure that enhances lithium ion conductivity, pellet density, and fracture strength. The disclosed solid electrolyte can be used in lithium-ion batteries, which are suitable for vehicle applications.

### CROSS-REFERENCE TO RELATED APPLICATION

This application claims, under 35 U.S.C. § 119(a), the benefit of Korean Patent Application No. 10-2024-0048990, filed on Apr. 12, 2024, the entire contents of which are incorporated herein by reference.

### TECHNICAL FIELD

The present disclosure relates to the field of solid electrolytes for us in electrochemical devices. More specifically, the present disclosure pertains to a sulfide solid electrolyte with an argyrodite crystal structure, design to enhance mechanical properties such as fracture strength. These solid electrolytes are particularly suitable for application in lithium-ion batteries, which can be used in various electronic devices and electric vehicles. The disclosure also covers methods for synthesizing these electrolytes and their integration into battery systems.

### BACKGROUND

Lithium secondary batteries, which may be charged and discharged, are used not only in small electronic devices such as mobile phones, laptops, etc., but also in large transportation vehicles such as hybrid vehicles, electric vehicles, etc. Accordingly, there is a need to develop secondary batteries having higher stability and energy density.

Most existing lithium secondary batteries are made up of cells based on liquid electrolytes, so there are limitations in improving stability and energy density.

Meanwhile, all-solid-state batteries using solid electrolytes, which are based on technology that excludes organic solvents, are recently in the spotlight because cells are manufactured in a safe and simple form.

Since the solid electrolyte is incombustible or flame retardant, safety thereof is higher than that of the liquid electrolyte.

Solid electrolytes are classified into oxide solid electrolytes and sulfide solid electrolytes. Sulfide solid electrolytes are mainly used because they have high lithium ion conductivity and are stable over a wide voltage range compared to oxide solid electrolytes.

However, sulfide solid electrolytes have lower chemical stability than oxide solid electrolytes, so operation of the battery is not stable. Accordingly, most research into sulfide solid electrolytes is limited to improving lithium ion conductivity and electrochemical stability.

SUMMARY OF THE DISCLOSURE

An object of the present disclosure is to provide a sulfide solid electrolyte for a lithium secondary battery with improved mechanical properties that greatly affect actual operation of the battery.

The objects of the present disclosure are not limited to the foregoing. The objects of the present disclosure will be able to be clearly understood through the following description and to be realized by the means described in the claims and combinations thereof.

An aspect of the present disclosure is related to a sulfide solid electrolyte for a lithium secondary battery, comprising a lithium element, a phosphorus element, a sulfur element, and one or more halogen element, wherein the sulfide electrolyte comprises an argyrodite crystal structure, and wherein the sulfide electrolyte comprises an antimony (Sb) element in Wyckoff position 48h of the argyrodite crystal structure. In some embodiments, a molar ratio of sum of the lithium element and the antimony element to the phosphorus element ((Li+Sb):P) is from about 4.9 to about 5.5.

In some embodiments, the sulfide solid electrolyte is represented by a formula: Li_{7-x-3y}Sb_{y}PS₆₋ₓHaₓ wherein the Ha is selected from the group consisting of fluorine (F), chlorine (Cl), bromine (Br), or iodine (I), and wherein the x is from 1.0 to 1.7 and the y is from 0 to 0.3.

In some embodiments, the sulfide solid electrolyte is represented by a formula: Li_{7-x-3y}Sb_{y}PS₆₋ₓ(Ha1ₐHa2₁₋ₐ)ₓ, wherein the Ha1 and the Ha2 are independently selected from the group consisting of fluorine (F), chlorine (Cl), bromine (Br), or iodine (I), wherein the x is from 1.0 to 1.7, the y is from 0 to 0.3, and the a is from 0 to 1.0, and wherein the Ha1 and the Ha2 are different elements.

In some embodiments, the sulfide solid electrolyte comprises a Raman spectrum peak between 400 cm⁻¹ and 450 cm⁻¹, wherein the Raman spectrum peak is downshifted from a Raman spectrum peak observed from a sulfide solid electrolyte not comprising antimony, and wherein the Raman spectrum peak is associated with a presence of the argyrodite crystal structure. In some embodiments, the sulfide solid electrolyte comprises exhibits a fracture strength of about 60 kPa or more as measured according to ASTM C773. In some embodiments, the sulfide solid electrolyte comprises has a pellet density from about 1.8 g/cm³ to about 2.0 g/cm³.

Another aspect of the present disclosure is related to a method of manufacturing a sulfide solid electrolyte for a lithium secondary battery, the method comprising: reacting a starting material comprising lithium sulfide, phosphorus sulfide, one or more lithium halide, and antimony sulfide to obtain a mixture thereof; and heat-treating the mixture to obtain a sulfide solid electrolyte, wherein the sulfide solid electrolyte comprises an argyrodite crystal structure, wherein the sulfide solid electrolyte comprises a lithium element, a phosphorus element, a sulfur element, and one or more halogen element, and wherein the sulfide solid electrolyte comprises an antimony (Sb) element in in Wyckoff position 48h of the argyrodite crystal structure.

In some embodiments, the heat-treating is performed from about 450° C. to about 500° C. In some embodiments, the heat-treating the mixture is performed from about 10 to about 30 minutes. In some embodiments, a molar ratio of sum of the lithium element and the antimony element relative to the phosphorus element ((Li+Sb):P) in the sulfide solid electrolyte is from about 4.9 to about 5.5.

In some embodiments, the method produces a sulfide solid electrolyte is represented by a formula: Li_{7-x-3y}Sb_{y}PS₆₋ₓHaₓ wherein the Ha is selected from the group consisting of fluorine (F), chlorine (Cl), bromine (Br), or iodine (I), and wherein the x is from 1.0 to 1.7 and the y is from 0 to 0.3.

In some embodiments, the method produces a sulfide solid electrolyte is represented by a formula: Li_{7-x-3y}Sb_{y}PS₆₋ₓ(Ha1ₐHa2₁₋ₐ)ₓ, wherein the Ha1 and the Ha2 are independently selected from the group consisting of fluorine (F), chlorine (Cl), bromine (Br), or iodine (I), wherein the x is from 1.0 to 1.7, the y is from 0 to 0.3, and the a is from 0 to 1.0, and wherein the Ha1 and the Ha2 are different elements.

In some embodiments, the method produces a sulfide solid electrolyte comprising a Raman spectrum peak between 400 cm⁻¹ to 450 cm⁻¹, wherein the Raman spectrum peak is downshifted with an increasing amount of antimony element present in the sulfide solid electrolyte. In some embodiments, the method produces a sulfide solid electrolyte exhibiting a fracture strength of about 60 kPa or more as measured according to ASTM C773. In some embodiments, the method produces a sulfide solid electrolyte having a pellet density of about 1.8 g/cm³ to about 2.0 g/cm³.

In some embodiments, the reacting lithium sulfide, phosphorus sulfide, one or more lithium halide, and antimony sulfide comprises using a ball milling to uniformly mix the starting material and provide reaction energy. In some embodiments, the lithium halide is selected from the group consisting of LiF, LiCl, LiBr, LiI, and a combination thereof.

Another aspect of the present disclosure is related to a lithium secondary battery, comprising: a cathode layer; an anode layer; and a solid electrolyte layer disposed between the cathode layer and the anode layer, wherein at least one of the cathode layer, the anode layer, or the solid electrolyte layer comprises the sulfide solid electrolyte of the present disclosure.

Lastly, another aspect of the present disclosure is related to a vehicle comprising the lithium secondary battery of the present disclosure.

As discussed, the method and system suitably include use of a controller or processer.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a lithium secondary battery according to the present disclosure.

FIG. 2 shows a ternary composition diagram of a sulfide solid electrolyte according to the present disclosure and a conventional sulfide solid electrolyte.

FIG. 3 shows an argyrodite crystal structure.

FIG. 4 shows Raman spectra of sulfide solid electrolytes according to Comparative Example 2, Example 2, and Comparative Example 4.

FIG. 5 is an enlarged view of the peaks in the range of 400 cm⁻¹ to 450 cm⁻¹ in FIG. 4.

FIG. 6 shows Raman spectra of the sulfide solid electrolytes according to Comparative Example 2, Example 2, Example 3, and Comparative Example 3.

FIG. 7 shows an enlarged view of the peaks in the range of 400 cm⁻¹ to 450 cm⁻¹ in FIG. 6.

FIG. 8 shows results of X-ray diffraction analysis of the sulfide solid electrolytes according to Comparative Example 2, Example 2, and Comparative Example 4.

FIG. 9 shows an enlarged view of specific portions of FIG. 8.

FIG. 10 shows results of X-ray diffraction analysis of the sulfide solid electrolytes according to Comparative Example 2, Example 2, Example 3, and Comparative Example 3.

FIG. 11 shows an enlarged view of specific portions of FIG. 10.

FIG. 12 shows results of X-ray diffraction analysis of the sulfide solid electrolytes according to Comparative Example 2 and Comparative Examples 11 to 13.

FIG. 13 shows results of evaluation of cell performance of lithium secondary batteries including the sulfide solid electrolytes according to Comparative Example 2, Example 2, and Comparative Example 10.

### DETAILED DESCRIPTION OF EMBODIMENTS

The above and other objects, features and advantages of the present disclosure will be more clearly understood from the following preferred embodiments taken in conjunction with the accompanying drawings. However, the present disclosure is not limited to the exemplary embodiments disclosed herein, and may be modified into different forms. These exemplary embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof.

It will be understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

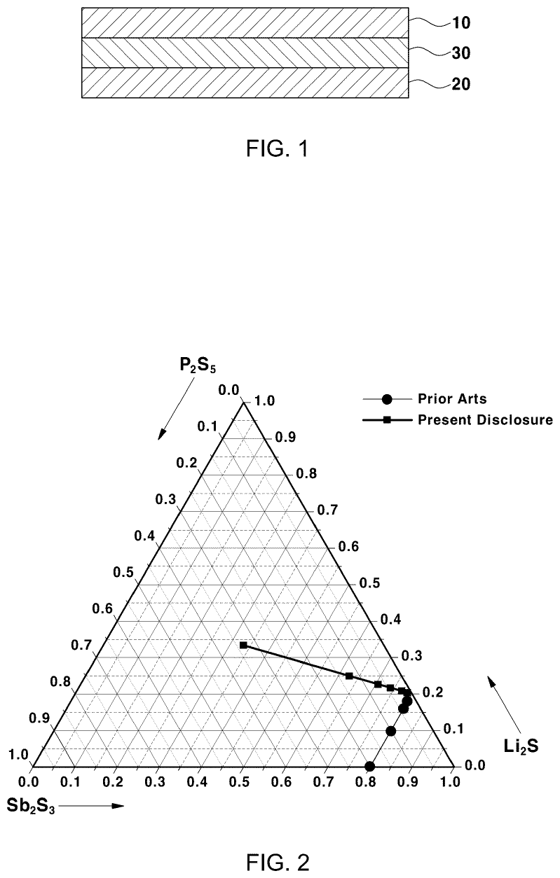

FIG. 1 shows a lithium secondary battery according to the present disclosure. The lithium secondary battery may include an all-solid-state battery. In some embodiments, the lithium secondary battery may include a cathode layer 10, an anode layer 20, and a solid electrolyte layer 30 disposed between the cathode layer 10 and the anode layer 20. In some embodiments, at least one of the anode layer 10, the cathode layer 20, or the solid electrolyte layer 30 may include a sulfide solid electrolyte according to the present disclosure.

In some embodiments, the sulfide solid electrolyte may include a lithium (Li) element, a phosphorus (P) element, a sulfur (S) element, and one or more halogen element. In some embodiments, the sulfide solid electrolyte may include an antimony (Sb) element that substitutes for at least a portion of lithium. In some embodiments, the sulfide solid electrolyte may include a compound represented by Formula 1 below and/or a compound represented by Formula 2 below.

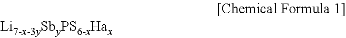

In Chemical Formula 1, Ha may include fluorine (F), chlorine (Cl), bromine (Br), or iodine (I), and x may be from 1.0 to 1.7 and y may be from 0 to 0.3.

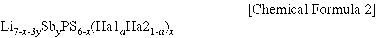

In Chemical Formula 2, Ha1 and Ha2 may include different elements, and Ha1 and Ha2 each may independently include fluorine (F), chlorine (Cl), bromine (Br), or iodine (I). In some embodiments, and x may be from 1.0 to 1.7, y may be from 0 to 0.3, and a may be from 0 to 1.0.

Conventionally, thorough research has been carried out to introduce various substitution elements to improve lithium ion conductivity and electrochemical stability of sulfide solid electrolytes. Although phosphorus (P) element is mainly substituted in the conventional method, the present disclosure is characterized by improving mechanical properties of the sulfide solid electrolyte by substituting lithium (Li) element.

In some embodiments, the sulfide solid electrolyte may be configured such that lithium (Li) element is substituted with antimony (Sb) element, and accordingly, the molar ratio of the sum of lithium (Li) element and antimony (Sb) element relative to phosphorus (P) element ((Li+Sb)/P) may be from about 4.9 to about 5.5. When phosphorus (P) element is substituted with a substitution element as in conventional cases, the molar ratio may be about 5.5 or more.

FIG. 2 shows the ternary composition diagram of the sulfide solid electrolyte according to the present disclosure and the conventional solid electrolyte in which phosphorus (P) element is substituted with antimony (Sb) element. Referring thereto, it may be seen that the composition ratios of the two sulfide solid electrolytes are completely different.

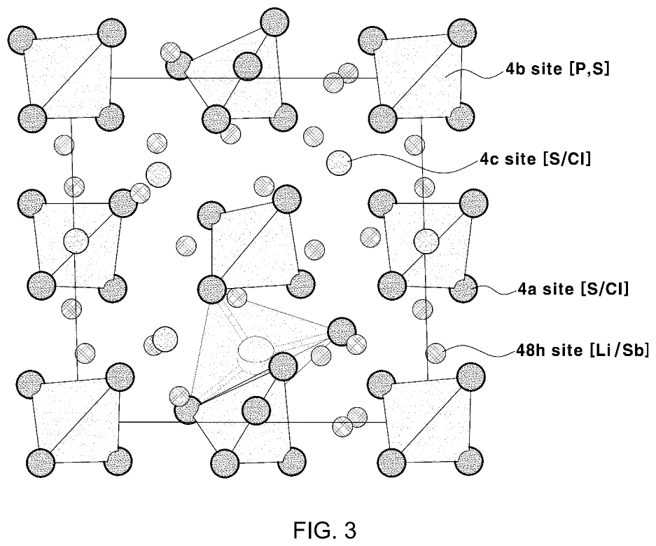

The sulfide solid electrolyte according to the present disclosure may have an argyrodite crystal structure as seen in FIG. 3. In some embodiments, the compound represented as Li₆PS₅Cl and having an argyrodite crystal structure may include a PS₄³-tetrahedron at Wyckoff position 4b, S2⁻ ions at 4a position and 4c position, and Li⁺ ions at 48h position. In some embodiments, the present disclosure is characterized by introducing antimony (Sb) element to at least a portion of Wyckoff position 48h.

In some embodiments, other elements may be substituted for lithium (Li) including, but not limited to trivalent cations derived from bismuth (Bi), niobium (Nb), scandium (Sc), tantalum (Ta), titanium (Ti), vanadium (V), etc., and/or divalent cations derived from calcium (Ca), chromium (Cr), iron (Fe), germanium (Ge), magnesium (Mg), titanium (Ti), vanadium (V), in addition to antimony (Sb).

The method of manufacturing the sulfide solid electrolyte is also disclosed herein. In some embodiments, the method may include preparing a starting material comprising lithium sulfide, phosphorus sulfide, lithium halide, and antimony sulfide, to obtaining a mixture by reacting the starting material, and heat-treating the product.

In some embodiments, the lithium sulfide is not particularly limited and may include Li₂S, Li₂S₂, Li₂S₄, Li₂S₅, and combinations thereof. In some embodiments, the phosphorus sulfide is not particularly limited and may include P₂S₃, P₂S₅, and a combination thereof. In some embodiments, the lithium halide is not particularly limited and may include LiF, LiCl, LiBr, LiI, and combinations thereof. In some embodiment, of the antimony sulfide is not particularly limited and may include Sb₂S₃, Sb₂S₅, and a combination thereof.

In some embodiments, the starting material may further include an elemental lithium, an elemental sulfur, an elemental phosphorus, or an elemental antimony.

The amount of the starting material may be appropriately adjusted to suit the composition of the final sulfide solid electrolyte, such that antimony (Sb) element may be substitute for a lithium (Li) element rather than a phosphorus (P) element.

In some embodiments, obtaining the mixture by reacting the starting material may be performed by a wet process or a dry process. For example, the starting material may be added to a solvent and stirred to cause collisions in the starting material such that the energy necessary for the reaction is generated by the collision. Alternatively, the starting material may be reacted by placing the starting material in a device such as a ball mill followed by grinding to directly apply the reaction energy and to ensure uniform distribution of the starting material within the mixture.

Next, the mixture is heat-treated to obtain a crystalline sulfide solid electrolyte having an argyrodite crystal structure. In some embodiments, antimony (Sb) element may be introduced as a substitution element. In some embodiments, if the heat treatment is carried out at a very high a temperature (i.e., above about 550° C.) for a very long period of time (i.e., more than 45 minutes), secondary impurities such as LiSbS₂ and the like are be generated. Accordingly, the present disclosure may be characterized in that the product is heat-treated at about 450° C. to about 500° C. for about 10 to about 30 minutes to reduce or to prevent generation of impurities.

A better understanding of the present disclosure may be obtained through the following examples. These examples are merely set forth to illustrate the present disclosure, and are not to be construed as limiting the scope of the present disclosure.

### Examples 1 to 4

A starting material was prepared by weighing Li₂S, P₂S₅, LiCl, and Sb₂S₃ according to the composition of each compound below. The product obtained by grinding the starting material using a ball mill heat-treating the mixture at about 500° C. for about 25 minutes, yielding a sulfide solid electrolyte.
Example 1: Li_{5.35}Sb_{0.05}PS_{4.5}Cl_{1.5}
Example 2: Li_{5.2}Sb_{0.1}PS_{4.5}Cl_{1.5}
Example 3: Li_{4.9}Sb_{0.2}PS_{4.5}Cl_{1.5}
Example 4: Li_{4.6}Sb_{0.3}PS_{4.5}Cl_{1.5}

### Comparative Examples 1 and 2

A starting material was prepared by weighing Li₂S, P₂S₅, and LiCl according to the composition of each compound below. The product obtained by grinding the starting material using a ball mill and heat-treating the mixture at about 550° C. for about 300 minutes, yielding a sulfide solid electrolyte.
Comparative Example 1: Li₆PS₅Cl
Comparative Example 2: Li_{5.5}PS_{4.5}Cl_{1.5}

### Comparative Example 3

A starting material was prepared by weighing Li₂S, P₂S₅, LiCl, and Sb₂S₃ according to the composition of Li₄Sb_{0.5}PS_{4.5}Cl_{1.5}. The product obtained by grinding the starting material using a ball mill and heat-treating the mixture at about 450° C. for about 25 minutes, yielding a sulfide solid electrolyte.

### Comparative Examples 4 to 6

A starting material was prepared by weighing Li₂S, P₂S₅, LiCl, and Sb₂S₃ according to the composition of each compound below. The product obtained by grinding the starting material using a ball mill and heat-treating the mixture at about 550° C. (Comparative Examples 4 and 5) or about 450° C. (Comparative Example 6) for about 25 minutes, yielding a sulfide solid electrolyte.
Comparative Example 4: Li_{5.5}P_{0.9}Sb_{0.1}S_{4.4}Cl_{1.5}
Comparative Example 5: Li_{5.5}P_{0.8}Sb_{0.2}S_{4.3}Cl_{1.5}
Comparative Example 6: Li_{5.5}P_{0.5}Sb_{0.5}S₄Cl_{1.5}

### Comparative Examples 7 to 10

A starting material was prepared by weighing Li₂S, P₂S₅, LiCl, and LiBr according to the composition of each compound below. The product obtained by grinding the starting material using a ball mill and heat-treating at about 550° C. for about 25 minutes, yielding a sulfide solid electrolyte.
Comparative Example 7: Li_{5.5}PS_{4.5}Cl_{1.4}Br_{0.1}
Comparative Example 8: Li_{5.5}PS_{4.5}Cl_{1.2}Br_{0.3}
Comparative Example 9: Li_{5.5}PS_{4.5}Cl_{1.0}Br_{0.5}
Comparative Example 10: Li_{5.5}PS_{4.5}Cl_{0.7}Br_{0.8}

### Comparative Example 11

A sulfide solid electrolyte was manufactured in the same manner as in Example 2, with the exception that the temperature and time conditions for heat treatment were changed to about 550° C. and about 300 minutes.

### Comparative Example 12

A sulfide solid electrolyte was manufactured in the same manner as in Example 3, with the exception that the temperature and time conditions for heat treatment were changed to about 550° C. and about 300 minutes.

### Comparative Example 13

A sulfide solid electrolyte was manufactured in the same manner as in Comparative Example 3, with the exception that the temperature and time conditions for heat treatment were changed to about 550° C. and about 300 minutes.

### Measurement of Lithium Ion Conductivity, Pellet Density, and Fracture Strength

The lithium ion conductivity of each sulfide solid electrolyte as prepared above was measured. Specifically, each sulfide solid electrolyte was compression molded to produce a molded body for measurement (13 mm in diameter, 1 to 1.5 mm in thickness). After applying an alternating potential of 10 mV to the molded body, a frequency sweep of 1×10⁶ to 1 Hz was performed to measure the impedance value, and lithium ion conductivity was calculated therefrom.

The pellet density of each sulfide solid electrolyte was measured using a pellet density tester. About 3 g of each sulfide solid electrolyte was placed in a container having a predetermined diameter and pressed at about 1,000 kgf/cm², and the pellet density was measured.

The fracture strength of each sulfide solid electrolyte was measured according to ASTM C773.

The composition, heat treatment conditions, lithium ion conductivity, pellet density, and fracture strength of each sulfide solid electrolyte are shown in Table 1 below.

TABLE 1

| | | | Lithium ion | Pellet | Fracture |
|---|---|---|---|---|---|
| | | Heat treatment | conductivity | density | strength |
| Sample | Composition | conditions | [mS/cm] | [g/cm³] | [kPa] |
| Comparative | Li₆PS₅Cl | 550° C., 300 min | 2.18 | 1.65 | 25.71 |
| Example 1 | | | | | |
| Comparative | Li_{5.5}PS_{4.5}Cl_{1.5} | 550° C., 300 min | 4.06 | 1.68 | 26.99 |
| Example 2 | | | | | |
| Example 1 | Li_{5.35}Sb_{0.05}PS_{4.5}Cl_{1.5} | 500° C., 25 min | 5.04 | 1.81 | 60.87 |
| Example 2 | Li_{5.2}Sb_{0.1}PS_{4.5}Cl_{1.5} | 500° C., 25 min | 6.92 | 1.89 | 143.12 |
| Example 3 | Li_{4.9}Sb_{0.2}PS_{4.5}Cl_{1.5} | 500° C., 25 min | 1.66 | 1.97 | 150.81 |
| Example 4 | Li_{4.6}Sb_{0.3}PS_{4.5}Cl_{1.5} | 500° C., 25 min | 2.04 | 1.91 | 108.63 |
| Comparative | Li₄Sb_{0.5}PS_{4.5}Cl_{1.5} | 450° C., 25 min | 0.0689 | 2.03 | 53.04 |
| Example 3 | | | | | |
| Comparative | Li_{5.5}P_{0.9}Sb_{0.1}S_{4.4}Cl_{1.5} | 550° C., 25 min | 2.7 | 1.86 | 138.15 |
| Example 4 | | | | | |
| Comparative | Li_{5.5}P_{0.8}Sb_{0.2}S_{4.3}Cl_{1.5} | 550° C., 25 min | 1.62 | 1.95 | 142.75 |
| Example 5 | | | | | |
| Comparative | Li_{5.5}P_{0.5}Sb_{0.5}S₄Cl_{1.5} | 450° C., 25 min | 0.0491 | 2.01 | 48.55 |
| Example 6 | | | | | |
| Comparative | Li_{5.5}PS_{4.5}Cl_{1.4}Br_{0.1} | 550° C., 25 min | 4.21 | 1.70 | 26.71 |
| Example 7 | | | | | |
| Comparative | Li_{5.5}PS_{4.5}Cl_{1.2}Br_{0.3} | 550° C., 25 min | 6.08 | 1.69 | 30.37 |
| Example 8 | | | | | |
| Comparative | Li_{5.5}PS_{4.5}Cl_{1.0}Br_{0.5} | 550° C., 25 min | 7.62 | 1.72 | 36.35 |
| Example 9 | | | | | |
| Comparative | Li_{5.5}PS_{4.5}Cl_{0.7}Br_{0.8} | 550° C., 25 min | 9.33 | 1.75 | 39.48 |
| Example 10 | | | | | |

Comparative Examples 1 and 2 are general sulfide solid electrolytes. Comparative Examples 1 and 2 have very low fracture strength of about 25 kPa to about 27 kPa. Hence, application thereof to lithium secondary batteries with large volume expansion results in deteriorated cell performance due to low resistance to stress.

In Examples 1 to 4 and Comparative Example 3, lithium (Li) element was substituted with antimony (Sb) element. In Comparative Example 3, antimony (Sb) element was introduced in an amount falling outside the range of the present disclosure. Examples 1 to 4 exhibit much higher fracture strength than Comparative Examples 1 and 2. Also, when the number of moles of antimony (Sb) element is between about 0.05 and about 0.1, lithium ion conductivity was observed to be very high. This behavior may be due to at these conditions, vacancies are created in the lithium site, allowing lithium ions to move more easily. As observed in Comparative Example 3, when an excess of antimony (Sb) element is substituted, both lithium ion conductivity and fracture strength decrease. As will be described later, when the number of moles of antimony (Sb) element increases, a completely different crystal phase is created, making it unable to function as a solid electrolyte. Also, Examples 1 to 4 exhibit greater pellet density than Comparative Examples 1 and 2.

In some embodiments, the sulfide solid electrolyte according to the present disclosure may have a pellet density of about 1.8 g/cm3 to about 2.0 g/cm³. When the pellet density of the sulfide solid electrolyte falls in this, rate characteristics of the secondary battery may be improved by increasing the density of the anode layer, cathode layer, and/or solid electrolyte layer including the sulfide solid electrolyte.

In addition, the sulfide solid electrolyte according to the present disclosure may exhibit fracture strength of 60 kPa or more as measured according to ASTM C773. The upper limit of fracture strength is not particularly limited. For example, fracture strength of the sulfide solid electrolyte may be about 300 kPa or less, about 250 kPa or less, or about 200 kPa or less. When the fracture strength of the sulfide solid electrolyte falls in the above range, the sulfide solid electrolyte is capable of maintaining the original shape well without being affected by volume expansion due to charging and discharging of the lithium secondary battery.

In Comparative Examples 4 to 6, phosphorus (P) element was substituted with antimony (Sb) element. When compared with Examples 1 to 4, lithium ion conductivity and fracture strength were observed to be low.

In Comparative Examples 7 to 10, Cl and Br were substituted in a 1:1 ratio in the base composition of Li_{5.5}PS_{4.5}Cl_{1.5}. When compared with Examples 1 to 4, the pellet density and fracture strength were observed to be very low.

### Raman Spectrum

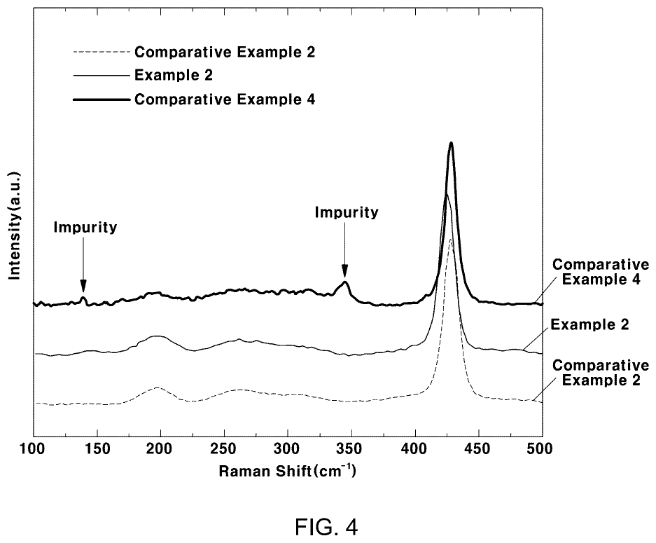

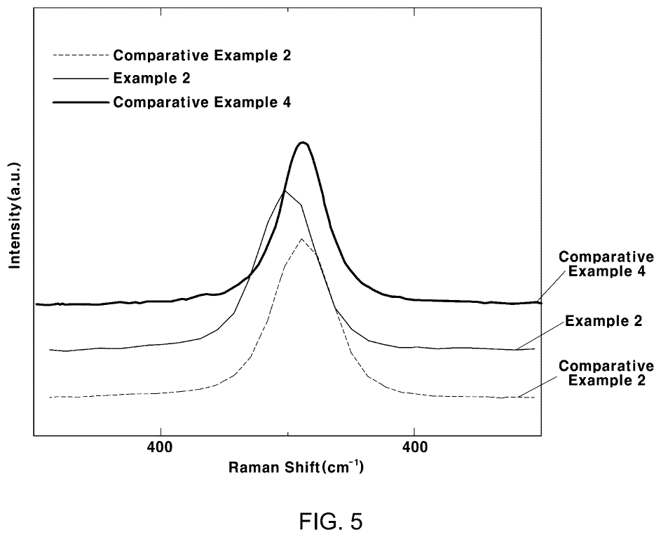

FIG. 4 shows Raman spectra of the sulfide solid electrolytes according to Comparative Example 2 (Li_{5.5}PS_{4.5}Cl_{1.5}), Example 2 (Li_{5.2}Sb_{0.1}PS_{4.5}Cl_{1.5}), and Comparative Example 4 (Li_{5.5}P_{0.9}Sb_{0.1}S_{4.4}Cl_{1.5}). FIG. 5 is an enlarged view of the peaks in the range of 400 cm⁻¹ to 450 cm⁻¹ in FIG. 4.

In Comparative Example 2 and Example 2, a peak associated with argyrodite crystal between 400 cm⁻¹ to 450 cm⁻¹ of Raman spectrum were downshifted. On the other hand, in Comparative Examples 2 and 4, the outlines of the peaks are substantially the same. Also, Comparative Example 4 exhibited many impurity peaks.

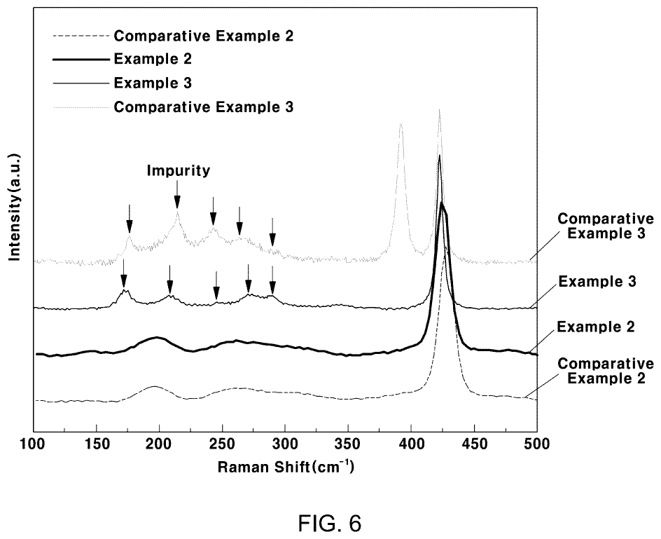

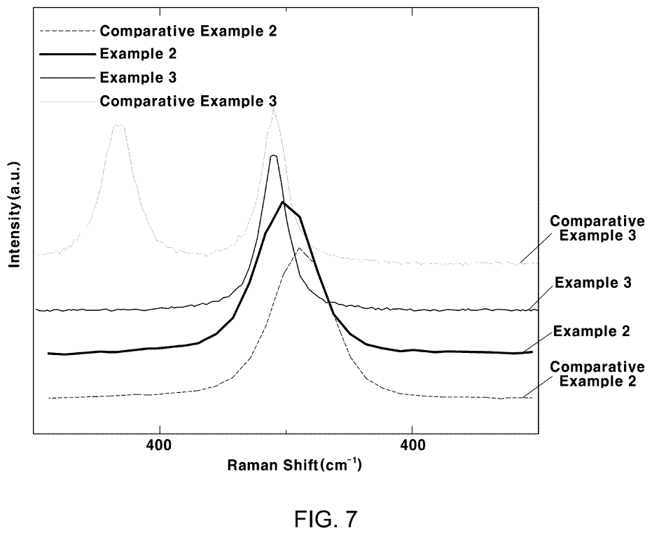

FIG. 6 shows Raman spectra of the sulfide solid electrolytes according to Comparative Example 2 (Li_{5.5}PS_{4.5}Cl_{1.5}), Example 2 (Li_{5.2}Sb_{0.1}PS_{4.5}Cl_{1.5}), Example 3 (Li_{4.9}Sb_{0.2}PS_{4.5}Cl_{1.5}), and Comparative Example 3 (Li₄Sb_{0.5}PS_{4.5}Cl_{1.5}). FIG. 7 is an enlarged view of the peaks observed in the range between 400 cm⁻¹ and 450 cm⁻¹ in FIG. 6.

Referring to FIGS. 6 and 7, in Examples 2 and 3 in which antimony (Sb) was present, the respective peaks between 400 cm⁻¹ and 450 cm⁻¹ of Raman spectrum were downshifted compared to Comparative Example 2 in which antimony (Sb) element was not present. The effective ionic radii of antimony ions (Sb³⁺) and lithium ions (Li⁺) are similar at about 76 pm, but such peak downshift may be due to a difference in atomic weight. The downshift of the peak between 400 cm⁻¹ and 450 cm⁻¹ is evidence that lithium (Li) element is substituted with antimony (Sb) element. Meanwhile, in Comparative Example 3, a completely different bond vibration mode occurs at about 390 cm⁻¹ or less, which is consistent with a rapid decrease in lithium ion conductivity and fracture strength in Table 1.

### X-ray Diffraction Analysis

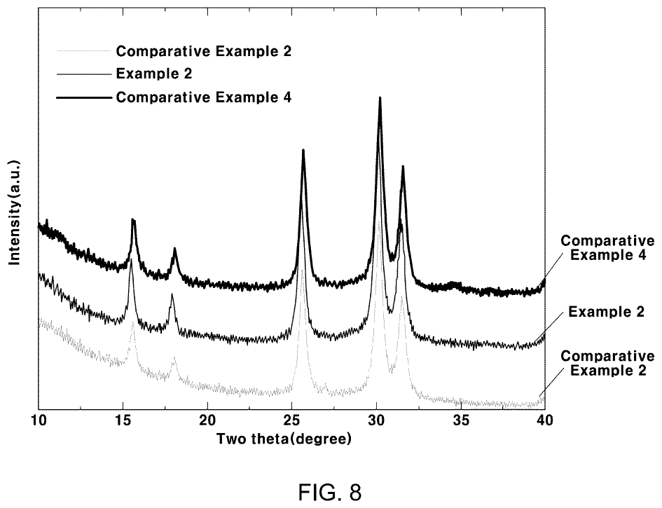

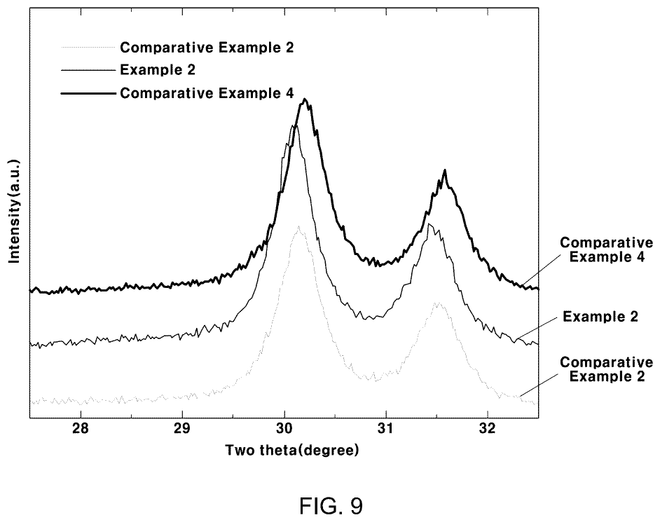

FIG. 8 shows results of X-ray diffraction analysis of the solid electrolyte sulfides according to Comparative Example 2 (Li_{5.5}PS_{4.5}Cl_{1.5}), Example 2 (Li_{5.2}Sb_{0.1}PS_{4.5}Cl_{1.5}), and Comparative Example 4 (Li_{5.5}P_{0.9}Sb_{0.1}S_{4.4}Cl_{1.5}). FIG. 9 is an enlarged view of specific portions of FIG. 8.

In Comparative Examples 2 and 4, the outlines of the peaks are substantially the same, similar to the Raman spectrum. This may be because antimony (Sb) element did not substitute for phosphorus (P) element and did not undergo solid solution in Comparative Example 4.

When comparing Comparative Example 2 with Example 2, the sulfide solid electrolyte according to the present disclosure may be found to maintain the argyrodite crystal structure in that, although there is a shift in the peak, it falls within the error range.

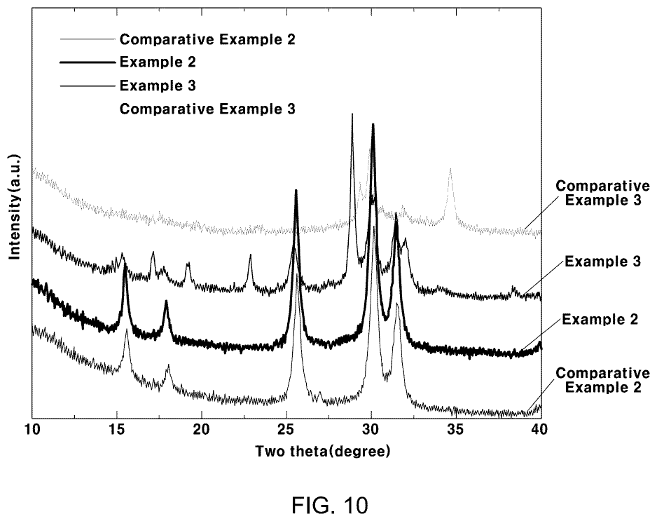

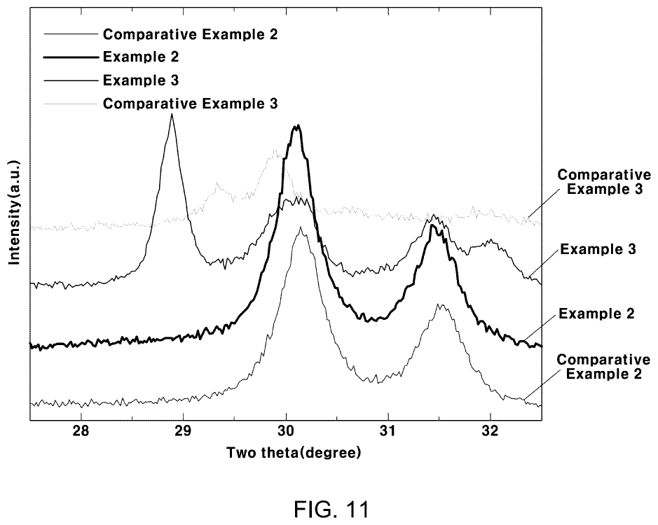

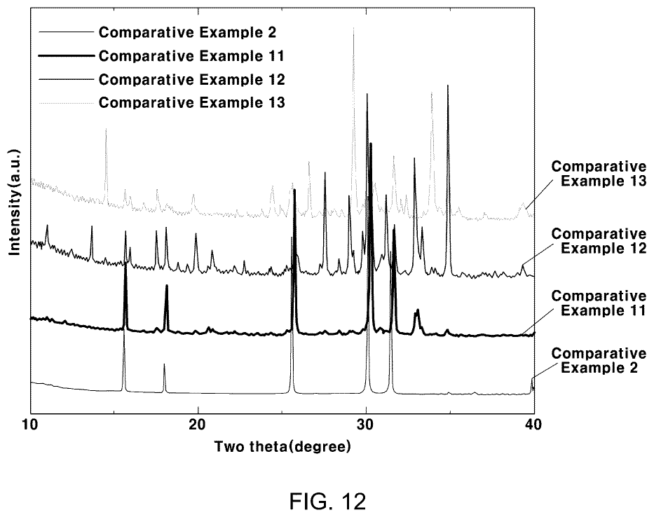

FIG. 10 shows results of X-ray diffraction analysis of the sulfide solid electrolytes according to Comparative Example 2 (Li_{5.5}PS_{4.5}Cl_{1.5}), Example 2 (Li_{5.2}Sb_{0.1}PS_{4.5}Cl_{1.5}), Example 3 (Li_{4.9}Sb_{0.2}PS_{4.5}Cl_{1.5}), and Comparative Example 3 (Li₄Sb_{0.5}PS_{4.5}Cl_{1.5}). FIG. 11 is an enlarged view of specific portions of FIG. 10. FIG. 12 shows results of X-ray diffraction analysis of the sulfide solid electrolytes according to Comparative Example 2 (Li_{5.5}PS_{4.5}Cl_{1.5}) and Comparative Examples 11 to 13. Comparative Examples 11, 12, and 13 had the same compositions as Example 2, Example 3, and Comparative Example 3, respectively, but the heat treatment conditions were increased to 550° C. and 300 minutes. Based on the results of Raman spectrum and X-ray diffraction analysis, lithium (Li) was confirmed to exert stress on PS₄³-anions, indicating substitution.

Referring to FIG. 12, it may be found that, when the temperature and time for heat treatment are increased, impurities are generated in a very large amount. In Examples 2 and 3 of FIG. 10, where temperature and time of the heat-treatment was maintained at about 500° C., for about 25 min, no impurities were generated due to heat treatment at a relatively low temperature for a short time period. Meanwhile, Comparative Example 3 shows a completely different crystal phase peak. This result is consistent with a rapid decrease in lithium ion conductivity and fracture strength of Comparative Example 3 in Table 1.

### Evaluation of Cell Performance

A lithium secondary battery was manufactured using the sulfide solid electrolyte of each of Comparative Example 2 (Li_{5.5}PS_{4.5}Cl_{1.5}), Example 2 (Li_{5.2}Sb_{0.1}PS_{4.5}Cl_{1.5}), and Comparative Example 10 (Li_{5.5}PS_{4.5}Cl_{0.7}Br_{0.8}).

A cathode material powder including a nickel-cobalt-manganese cathode active material, a solid electrolyte represented as Li₆PS₅Cl, a conductive material, and a binder was prepared. The cathode material powder was placed in a mold, the sulfide solid electrolyte of each of Comparative Example 2, Example 2, and Comparative Example 10 was placed thereon, and a pressure of about 54 MPa was applied thereto, forming a stack of a cathode layer and a solid electrolyte layer. A lithium secondary battery was obtained by attaching lithium metal to the upper surface of the solid electrolyte layer.

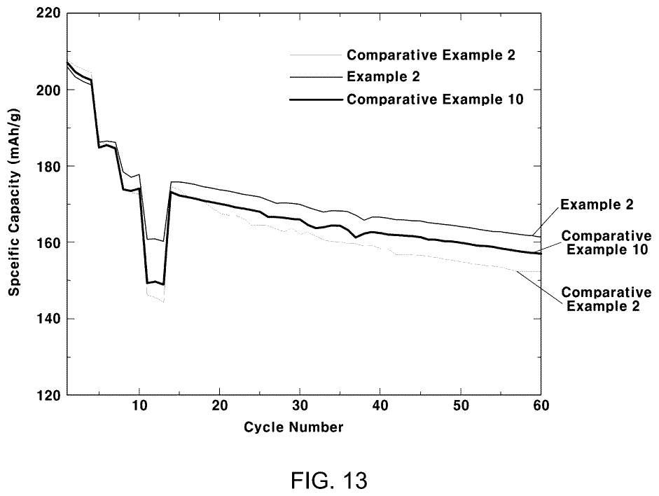

Each lithium secondary battery was charged and discharged under the following conditions and the capacity thereof was measured. The results thereof are as shown in FIG. 13.
Charging conditions: CC (˜3.7 V)−C/20 & CV (3.7 V)−limiting current of C/10
Discharging conditions: CC (˜2.2 V)−C/20

Referring to Table 1, lithium ion conductivity is higher in Comparative Example 10 than in Example 2. However, referring to FIG. 13, Example 2 shows better cell performance than Comparative Example 10. This behavior may be due to excellent mechanical properties of Example 2, efficiently forming and maintaining the interface between the anode layer and the cathode layer and improving durability of the solid electrolyte layer. It may be found that performance of the lithium secondary battery is greatly influenced not only by lithium ion conductivity but also by mechanical properties.

As is apparent from the above description, according to the present disclosure, it is possible to obtain a sulfide solid electrolyte for a lithium secondary battery with excellent mechanical properties. Furthermore,, it may be possible to obtain a sulfide solid electrolyte for a lithium secondary battery that has excellent ductility and toughness and also has high fracture strength. Moreover, it may be possible to obtain a sulfide solid electrolyte for a lithium secondary battery that shows excellent performance when applied to an all-solid-state battery with large volume expansion.

The effects of the present disclosure are not limited to the foregoing. It should be understood that the effects of the present disclosure include all effects that may be inferred from the description of the present disclosure.

As the examples of the present disclosure have been described in detail above, the scope of the present disclosure is not limited to the aforementioned examples, and various modifications and improvements made by those skilled in the art using the basic concept of the present disclosure defined in the following claims are also within the scope of the present disclosure.

1. A sulfide solid electrolyte for a lithium secondary battery, the sulfide solid electrolyte comprising a lithium element, a phosphorus element, a sulfur element, and one or more halogen element,
wherein the sulfide electrolyte comprises an argyrodite crystal structure,
wherein the sulfide electrolyte comprises an antimony (Sb) element in Wyckoff position 48h of the argyrodite crystal structure and,
wherein a molar ratio of sum of the lithium element and the antimony element to the phosphorus element ((Li+Sb):P) is from 4.9 to 5.5.

2. (canceled)

3. The sulfide solid electrolyte of claim 1 represented by a formula: 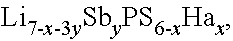
wherein the Ha is selected from the group consisting of fluorine (F), chlorine (Cl), bromine (Br), or iodine (I), and
wherein the x is from 1.0 to 1.7 and the y is greater than 0 and less than or equal to 0.3.

4. The sulfide solid electrolyte of claim 1 represented by a formula: 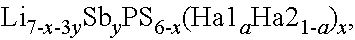
wherein the Ha1 and the Ha2 are independently selected from the group consisting of fluorine (F), chlorine (Cl), bromine (Br), or iodine (I),
wherein the x is from 1.0 to 1.7, the y is greater than 0 and less than or equal to 0.3, and the a is from 0 to 1.0, and
wherein the Ha1 and the Ha2 are different elements.

5. The sulfide solid electrolyte of claim 1 comprising a Raman spectrum peak between 400 cm⁻¹ and 450 cm⁻¹,
wherein the Raman spectrum peak is downshifted from a Raman spectrum peak observed from a sulfide solid electrolyte not comprising antimony, and
wherein the Raman spectrum peak is associated with a presence of the argyrodite crystal structure.

6. The sulfide solid electrolyte of claim 1, wherein the sulfide solid electrolyte exhibits a fracture strength of 60 kPa or more as measured according to ASTM C773.

7. The sulfide solid electrolyte of claim 1, wherein the sulfide solid electrolyte has a pellet density from 1.8 g/cm³ to about 2.0 g/cm³.

8. A method of manufacturing a sulfide solid electrolyte for a lithium secondary battery, the method comprising:
reacting a starting material comprising lithium sulfide, phosphorus sulfide, one or more lithium halide, and antimony sulfide to obtain a mixture thereof; and
heat-treating the mixture to obtain a sulfide solid electrolyte,
wherein the sulfide solid electrolyte comprises an argyrodite crystal structure,
wherein the sulfide solid electrolyte comprises a lithium element, a phosphorus element, a sulfur element, and one or more halogen element, and
wherein the sulfide solid electrolyte comprises an antimony (Sb) element in in Wyckoff position 48h of the argyrodite crystal structure.

9. The method of claim 8, wherein the heat-treating is performed from about 450° C. to about 500° C.

10. The method of claim 8, wherein the heat-treating the product is performed from about 10 to about 30 minutes.

11. The method of claim 8, wherein a molar ratio of sum of the lithium element and the antimony element relative to the phosphorus element ((Li+Sb):P) in the sulfide solid electrolyte is from about 4.9 to about 5.5.

12. The method of claim 8, wherein the sulfide solid electrolyte is represented a formula: 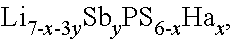
wherein the Ha is selected from the group consisting of fluorine (F), chlorine (Cl), bromine (Br), and iodine (I), and
wherein the x is from 1.0 to 1.7 and the y is from 0 to 0.3.

13. The method of claim 8, wherein the sulfide solid electrolyte is represented by a formula: 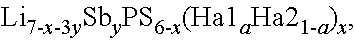
wherein the Ha1 and the Ha2 are independently comprise fluorine (F), chlorine (Cl), bromine (Br), or iodine (I),
wherein the x is from 1.0 to 1.7, the y is from 0.3 to 0.3, and the a is from 0 to 1.0, and
wherein the Ha1 and the Ha2 are different elements.

14. The method of claim 8, wherein the sulfide solid electrolyte comprises a Raman spectrum peak between 400 cm⁻¹ to 450 cm⁻¹, and
wherein the Raman spectrum peak is downshifted with an increasing amount of antimony element present in the sulfide solid electrolyte.

15. The method of claim 8, wherein the sulfide solid electrolyte exhibits a fracture strength of about 60 kPa or more as measured according to ASTM C773.

16. The method of claim 8, wherein the sulfide solid electrolyte has a pellet density of about 1.8 g/cm³ to about 2.0 g/cm³.

17. The method of claim 8, wherein the reacting lithium sulfide, phosphorus sulfide, one or more lithium halide, and antimony sulfide comprises using a ball milling to uniformly mix the starting material and provide reaction energy.

18. The method of claim 8, wherein the lithium halide is selected from the group consisting of LiF, LiCl, LiBr, LiI, and a combination thereof.

19. A lithium secondary battery comprising:
a cathode layer;
an anode layer; and
a solid electrolyte layer disposed between the cathode layer and the anode layer,
wherein at least one of the cathode layer, the anode layer, or the solid electrolyte layer comprises the sulfide solid electrolyte of claim 1.

20. A vehicle comprising the lithium secondary battery of claim 19.
